(19) United States
(12) Patent Application Publication
(10) Pub. No.: US 2023/0303900 A1
(43) Pub. Date: Sep. 28, 2023

(54) HYBRID ALKYD-ACRYLIC BASED PRESSURE SENSITIVE ADHESIVES AND METHODS OF MAKING AND USING THEREOF

(71) Applicant: Avery Dennison Corporation, Mentor, OH (US)

(72) Inventor: Danny G. HARTINGER, Centre Hall, PA (US)

(21) Appl. No.: 17/758,233

(22) PCT Filed: Dec. 30, 2020
(86) PCT No.: PCT/US2020/067482

§ 371 Date: Jul. 28, 2022

Related U.S. Application Data
(60) Provisional application No. 62/956,366, filed on Jan. 2, 2020.
(60) Provisional application No. 62/961,243, filed on Jan. 15, 2020.

(51) Int. Cl. C09J 151/00; C09J 11/08; C08F 283/01

(52) U.S. Cl. CPC C09J 151/003; C09J 11/08; C08F 283/01; C09J 2301/414; C09J 2301/408; C09J 2301/302

(57) ABSTRACT

A biodegradable pressure sensitive adhesive comprising a water-dispersed polymer composition and methods of making and using thereof are described herein. The water-dispersed composition comprises or consists of core-shell polymer nano-sized particles, wherein the core comprises or consists of one or more alkyds and the shell comprises or consists of a (meth)acrylate polymer. The one or more alkyd core comprises one or more fatty acids and/or fatty acid esters derived from a non-drying oil.

### CROSS-REFERENCE TO RELATED APPLICATIONS

The present application claims the benefit of U.S. Provisional Patent Application Nos. 62/956,366 filed Jan. 2, 2020 and 62/961,243 filed Jan. 15, 2020, both of which are incorporated herein by reference in their entireties.

### FIELD

The present subject matter relates to methods of preparing pressure sensitive adhesives with novel architecture signified with a (meth)acrylate polymer shell which surrounds an alkyd core to which it may or may not be chemically bound. In many aspects, the alkyd core comprises one or more fatty acids and/or fatty acid esters derived from a non-drying oil. The present subject matter also relates to a method to recycle PET into the biodegradable pressure sensitive adhesives formed from the methods. Additionally, the present subject matter relates to tapes and other articles using the pressure sensitive adhesives.

### BACKGROUND OF THE INVENTION

A pressure sensitive adhesive (PSA) (also known as “self-adhesive” or “self stick adhesive”) is a non-reactive adhesive that forms a bond at room temperature with a variety of dissimilar surfaces when light pressure is applied; no water, solvent, heat, or radiation is needed to activate the adhesive. PSA's are soft polymeric materials that show permanent tackiness at room temperature and have sufficient cohesive strength to adhere to surfaces and/or bond multiple substrates together via noncovalent forces when light pressure is applied. PSAs adhere naturally while in their solid state and, therefore, differ drastically from other types of adhesives, such as glues, which are liquid upon application but solidify after a chemical reaction, or hot-melt (HM) adhesives, which are tacky in the molten state and harden when they are cooled to room temperature.

PSAs have applications in pressure-sensitive tapes and/or foils, general purpose labels, note pads, automobile trim, packaging materials, medical tapes and other medical devices, and a wide variety of other products. PSA's are extremely complex and multiform materials that must simultaneously possess ambivalent properties, such as a high molecular mobility, long relaxation times, a substantial cohesive strength and conformational restructuration upon aging. To date, important families of polymers for PSA applications belong to acrylic copolymers, natural rubbers, styrene-isoprene-styrene and styrene-butadiene-styrene block copolymers (SBCs), styrene-butadiene rubbers, olefin block copolymers (OBC) and polysiloxanes. Although these classes of polymers have excellent PSA properties, they are derived from non-renewable petroleum resources and do not degrade in the natural environment, contributing to the problem of plastic pollution, both in landfills and in the ocean.

In addition to these well-established chemical families, polyesters and polyurethanes (based on polyester polyols) have recently been developed as alternatives for pressure-sensitive adhesives. The use of renewable raw materials derived from biological sources provides one option for increasing the sustainability of self-adhesive products based on these two polymer chemistries. In the hierarchy of sustainability though, recycling of polymers provides even greater benefits than starting with bio derived materials and the thermoplastic polyethylene terephthalate (PET), for example, has been the focus of much research in the area of recyclability. However, due to its high glass transition temperature (Tg) and crystallinity, PET by itself is wholly unsuitable for making a PSA. One way to ameliorate both of these negative properties, and to maintain a high bio derived raw material content is to incorporate PET into an alkyd type polymer.

Alkyd compositions have been widely used in the coatings and paint industries to provide, among other things, corrosion resistance and the ability to wet out and adhere to surfaces to which the coating or paint containing the alkyd composition is applied. These polymers by nature have low intrinsic viscosities and can be formulated into high solids solvent-based coatings. There are two broad categories of alkyds, namely drying and non-drying. The drying alkyds are derived from natural oils containing a high degree of polyunsaturation and, in the presence of certain metal driers, undergo oxidative cross linking when exposed to air to form a hard protective coating. In contrast, non-drying alkyds are made from natural oils containing predominantly saturated fatty acids and/or monounsaturated fatty acids that do not readily undergo oxidative cross linking reactions. These non-drying alkyds act as moderate to high molecular weight polyols that are cross linked with melamine-formaldehyde resins or polyisocyanate compounds to provide a hard durable finish.

Regulations related to volatile organic compounds (VOCs) have mandated that the coatings industry decrease the VOC content of their products. In some situations, this has required a switch from solvent-based coatings to water-based or water-borne coatings, which has led to performance issues, especially regarding shelf life of the formulated product.

In particular, water-borne alkyds have a comparatively short shelf life, compared to their solvent based counterparts, due to poor hydrolytic stability. The shelf life of water-borne alkyd compositions is dependent, in part, upon the integrity of the ester linkages within the alkyd compositions. The ester linkages in the water-borne alkyd compositions are prone to hydrolysis. Hydrolysis of the ester linkages in a water-borne alkyd lowers the molecular weight and reduces the performance of the coating or paint.

In an effort to improve the hydrolytic stability of water-borne alkyds and to lower the VOCs, there have been developed acrylic modified alkyd dispersions in which a hydrolysis resistant acrylic polymer becomes a “shell” that covers and protects the alkyd “core” from hydrolysis in the water dispersion. The acrylic polymer, with suitable carboxylic acid functionality, can be made in-situ with the alkyd and subsequently dispersed in water or a separate acrylic polymer can be made and either blended with the alkyd or subsequently reacted with the alkyd prior to dispersing in water. These various methods have shown great promise in improving the shelf life stability of water dispersed alkyds.

Using this technology pathway, we have discovered a way to convert recycled PET into a pressure sensitive adhesive composition, while also maintaining a high bio derived content, that is biodegradable/compostable and does not contribute to plastic pollution to the environment. We describe herein water-dispersible polymer compositions containing one or more core-shell polymers dispersed throughout an aqueous-based continuous phase that may be utilized as compostable pressure-sensitive adhesives.

### SUMMARY

The difficulties and drawbacks associated with previous approaches are addressed in the present subject matter as follows.

A biodegradable pressure sensitive adhesive comprising a water-dispersed polymer composition and methods of making and using thereof are described herein. In some embodiments, the water-dispersed composition comprises or consists of core-shell polymer nano-sized particles. The core comprises or consists of one or more alkyds and the shell comprises or consists of a (meth)acrylate polymer, wherein the concentration of the one or more alkyd is from about 5% to about 95% by weight of the core shell polymer. In some embodiments, the core-shell polymer is as described above and the one or more alkyd core comprises one or more fatty acids and/or fatty acid esters derived from a non-drying oil. In some embodiments, the core-shell polymer is as described above and the one or more alkyd core comprises a polyol and polycarboxylic acid derived from PET.

In some embodiments, the core-shell polymer is as described above and the one or more alkyd core is covalently bound to the (meth)acrylate polymer shell. In alternative embodiments, the one or more alkyd core is not covalently bound to the (meth)acrylate polymer shell. In other alternative embodiments, the core-shell polymer particles include a combination of alkyd cores that are covalently bound to (meth)acrylate polymer shells and alkyd cores that are not covalently bound to (meth)acrylate polymer shells.

In some embodiments, the one or more alkyd is as described above and comprises or consists of a single alkyd or a mixture of alkyds. In some embodiments, the alkyds in the mixture have the same chemical composition but different molecular weights, different chemical compositions but the same or similar molecular weights, different chemical compositions and different molecular weights, and combinations thereof.

In some embodiments, the one or more alkyd is as described above and is prepared by the reaction of, or derived from, (i) a non-drying oil or non-drying oil fatty acids and/or esters, (ii) one or more mono-alcohol, dialcohol, or polyols, and (iii) one or more mono-carboxylic acid, dicarboxylic acid, or polycarboxylic acid. In some embodiment, the non-drying oil or non-drying oil fatty acids and/or esters is as described above and exhibits an iodine value of less than 125, or less than about 120, or less than about 110, or less than about 100, or less than about 90, or less than about 80, or less than about 70, or less than about 60, or less than about 50, or less than about 40, or less than about 30, or less than about 20, or less than about 10, or within a range of from about 5 to about 125, or about 5 to about 120, or about 5 to about 110, or about 5 to about 100, about 5 to about 90, or about 5 to about 80, or about 5 to about 70, about 5 to about 60, or about 5 to about 50, or about 5 to about 40, or about 5 to about 30, or about 5 to about 20, or about 5 to about 15, or about 5 to about 10. In some embodiment, the non-drying oil or non-drying oil fatty acids and/or esters is as described above and comprises a total concentration of less than about 50%, or less than about 40%, or less than about 30%, or less than about 20%, or less than about 15%, or less than about 10%, or about 5%, or less than about 3%, or less than about 2.0%, or less than about 1.0% polyunsaturated fatty acids, and/or fatty acid esters based on the total weight of the one or more alkyd. In some embodiment, the non-drying oil or non-drying oil fatty acids and/or esters is as described above and comprises at least one of, (i) fatty acids and/or fatty acid esters containing zero and/or one site of unsaturation, (ii) a total concentration of less than about 20% polyunsaturated fatty acids, and/or polyunsaturated fatty acid esters, and (iii) an iodine value of less than 90 according to ISO 3961-2018. In some embodiments, the core-shell polymer is as described above and the one or more mono-alcohol, dialcohol, or polyols, and the one or more mono-carboxylic acid, dicarboxylic acid, or polycarboxylic acid are derived from PET. In some embodiments, the core-shell polymer is as described above and the one or more alkyd comprises c8-c18 fatty acids or fatty acid esters, wherein the fatty acids and/or fatty acid esters contain zero and/or one site of unsaturation.

In a preferred embodiment, the one or more alkyd is as described above and comprises a terminally free radically polymerizable functional group (e.g., a carbon-carbon double bond). In some embodiment, the non-drying oil described above is selected from the group consisting of babassu oil, macadamia oil, almond oil, palm oil, cocoa butter, coconut oil, olive oil, avocado oil, and combinations thereof. In a most preferred embodiment, the non-drying oil is as described above and is coconut oil.

In some embodiments, the core-shell polymer is as described above and the one or more alkyd comprises from about 5% to about 95% by weight of the core-shell polymer. In another embodiment, the core-shell polymer is as described above, and the weight ratio of the alkyd to the (meth)acrylate polymer is within the range of from about 50:50 to about 95:5 of the core-shell polymer. In yet another embodiment, the core-shell polymer is as described above, and the weight ratio of the alkyd to the (meth)acrylate polymer is within the range of from about 70:30 to about 95:5 of the core-shell polymer.

In some embodiment the water-dispersed core-shell polymer particle is as described above and further comprises one or more tackifiers. In a preferred embodiment, the core-shell polymer particle is as described above and the one or more tackifier is homogeneously dispersed within the nano-sized core-shell polymer particles. Preferably, the one or more tackifier is compatible with the core-shell polymer and does not inhibit free radical polymerization. Compatibility is a measure of the solubility of a substance when mixed with another substance. If two substances are compatible, they will not phase separate over time. In some embodiment, the core-shell polymer is as described above and the one or more tackifier is a polyester oligomer having a weight average molecular weight (Mw) within a range of from about 300 g/mole to about 3000 g/mole as determined by gel permeation chromatography (GPC).

In some embodiment, the water-dispersed core-shell polymer is as described above and comprises about 30-80 wt % one or more alkyd, about 20-50% (meth)acrylate polymer, and about 0-50 wt % one or more tackifiers, wherein the weight of the components sums up to 100% based on the total weight of the core-shell polymer.

In some embodiments, the polyol that is used to make the one or more alkyds as described above, has at least 3 hydroxy groups, for example, 3, 4, 5, 6 or more hydroxyl groups and is selected from the group consisting of glycerol, trimethylolethane, trimethylolpropane, dipentaerythritol, pentaerythritol, sugar alcohols, and combinations thereof.

In some embodiments, the polycarboxylic acid that is used to make the one or more alkyds as described above, has at least 2 carboxylic acid groups and is selected from the group consisting of oxalic acid, malonic acid, succinic acid or anhydride, glutaric acid, adipic acid, pimelic acid, suberic acid, azelaic acid, sebacic acid, dodecanedioic acid, dimer fatty acids, phthalic acid or anhydride, isophthalic acid, terephthalic acid, naphthalene dicarboxylic acid, tetrahydrophthalic anhydride, hexahydrophthalic anhydride, methylhexahydrophthalic anhydride, cyclohexane dicarboxylic acid, norbornene anhydride, furan dicarboxylic acid, and combinations thereof.

In some embodiments, the one or more alkyds as described above, contain terminal free radically polymerizable functional groups that are obtained or derived from the group consisting of maleic anhydride, methacrylic anhydride, citraconic anhydride, crotonic acid, sorbic acid, and combinations thereof.

In some embodiments, the core-shell polymer is as described above and the (meth)acrylate polymer is prepared or derived from acrylates comprising Cl to about C20 alkyl, aryl, or cyclic acrylates, methacrylates comprising Cl to about C20 alkyl, aryl, or cyclic methacrylates, or mixtures thereof. Non-limiting examples of the monomers that may be used to prepare the (meth)acrylate polymer are selected from the group consisting of acrylic acid, methyl acrylate, ethyl acrylate, n-butyl acrylate, iso-butyl acrylate, n-hexyl acrylate, n-heptyl acrylate, n-octyl acrylate, isooctyl acrylate, 2-ethylhexyl acrylate, n-nonyl acrylate, isodecyl acrylate, 2-propyl heptyl acrylate, lauryl acrylate, isostearyl acrylate, β-carboxyethyl acrylate, hydroxyethyl acrylate, hydroxypropyl acrylate, hydroxybutyl acrylate, ethoxyethoxyethyl acrylate, methacrylic acid, n-butyl methacrylate, iso-butyl methacrylate, n-hexyl methacrylate, n-heptyl methacrylate, n-octyl methacrylate, isooctyl methacrylate, 2-ethylhexyl methacrylate, n-nonyl methacrylate, isodecyl methacrylate, 2-propyl heptyl methacrylate, lauryl methacrylate, isostearyl methacrylate, hydroxyethyl methacrylate, hydroxypropyl methacrylate, hydroxybutyl methacrylate and ethoxyethoxyethyl methacrylate.

In some embodiments, the water-dispersed core-shell polymer is as described above and further comprises a surfactant. In some embodiments, the water-dispersed core-shell polymer is as described above and comprises a copolymerizable surfactant selected from the non-limiting group consisting of allyl or vinyl substituted alkyl phenolethoxylates and their sulfates; block copolymers of polyethylene oxide, propylene oxide or butylene oxide with polymerizable end groups; allyl or vinyl substituted ethoxylated alcohols and their sulfates; maleate half esters of fatty alcohols; monoethanolamide ethoxylates of unsaturated fatty acids capable of undergoing autoxidative polymerization; allyl or vinyl polyalkylene glycol ethers; alkyl polyalkylene glycolether sulfates; functionalized monomer and surfactants; and combinations thereof.

In some embodiments, the (meth)acrylate polymer shell of the core-shell polymer is as described above and additionally contains a photoinitiator moiety in the form of a distinct agent that is added to the composition, or a photoinitiator moiety bound to the copolymer backbone, or a photoinitiator moiety formed in-situ by an association of materials or agents in the composition. Non-limiting examples of the photoinitiator include a photoinitiator selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof. The photoinitiator described above is activatable upon exposure to UV radiation to at least partially polymerize and/or crosslink the composition.

In some embodiments, the water-dispersed composition is as described above and further comprises additives selected from the group consisting of pigments, fillers, plasticizers, diluents, antioxidants, crosslinkers, chain extenders, and combinations thereof.

The molecular weight of the one or more alkyd can vary based on the desired properties of the alkyd, the core-shell polymer, or compositions containing the same. In some embodiments, the one or more alkyd is as described above and exhibits a weight average molecular weight (Mw) within a range of from about 1000 to about 50,000 g/mole as determined by gel permeation chromatography (GPC).

Materials that are suitable for use as, or in, pressure sensitive adhesive compositions typically have a low glass transition temperature. In some embodiments, the one or more alkyd is as described above and exhibits a glass transition temperature from about −100° C. to about 50° C., or about −100° C. to about 30° C., or about −100° C. to about 10, or about −100° C. to about −10° C. or about −70° C. to about 30° C., or about −40° C. to about −10° C. measured by differential scanning calorimetry (DSC).

In some embodiments of the core-shell polymer is as described above and exhibits a weight average molecular weight (Mw) of within a range of from about 5,000 to about 1,000,000 g/mole, or about 10,000 to about 500,000 g/mole, or about 20,000 to about 100,000 g/mole as determined by gel permeation chromatography (GPC).

In some embodiments, the water-dispersed composition is as described above and exhibits a viscosity within a range of from about 5 to about 1500 centipoise (Cp) at 20° C., or about 5 to about 500 Cp at 20° C. as measured using a rotational viscometer.

The size of the core-shell polymer particle as described above can vary. In some embodiments, the core-shell polymer is as described above and has an average particle size diameter range of from about 10 nm to about 2000 nm or about 50 nm to about 600 nm or about 100 nm to about 400 nm, or about 200 nm to about 400 nm, as measured by dynamic light scattering.

In some embodiments, the pressure sensitive adhesive is as described above and exhibits a plateau shear modulus at 25° C. and 1 radian per second that is between 5×10⁴ and 6×10⁶ dynes/cm² as determined by dynamic mechanical analysis (DMA).

In some embodiments, the pressure sensitive adhesive is as described above and a glass transition temperature from about −100° C. to about 20° C., or about −100° C. to about 10° C., or about −100° C. to about 0° C., or about −100° C. to about −10° C., or about −40° C. to about −10° C. measured by differential scanning calorimetry (DSC).

The fatty acids and/or fatty acid esters are covalently bound to the polyol via the acid or ester group of the fatty acid and/or fatty acid ester and the hydroxyl groups of the polyol via ester linkages. In some embodiments, the alkyds contain the same polyol core and the same fatty acids and/or fatty acid esters. In some embodiments, the alkyds contain different polyol cores and the same fatty acids and/or fatty acid esters. In still other embodiments, the alkyds contain different polyol cores and different fatty acids and/or fatty acid esters. In some embodiments, the fatty acids and/or fatty acid esters contain from about 6 to about 30 carbon atoms, or from about 8 to about 24 carbon atoms, or from about 8 to about 22 carbon atoms, or from about 8 to about 18 carbon atoms. In some embodiments, the fatty acids and/or fatty acid esters are as defined above and contain zero and or one site of unsaturation (e.g., double bonds).

The molecular weight of the alkyd(s) can vary based on the desired properties of the alkyd, the core-shell polymer, or compositions containing the same. In some embodiments, the weight average molecular weight (Mw) of the alkyd is within a range of from about 300 to about 30,000 g/mole as determined by gel permeation chromatography (GPC).

Methods of making the water-dispersed compositions are also described herein. In some embodiments, the method of making the water-dispersed compositions include the steps of (1) providing the one or more alkyd prepared by reacting (i) a non-drying oil or non-drying oil fatty acids and/or esters, (ii) one or more mono-alcohol, dialcohol, or polyols, and (iii) one or more mono-carboxylic acid, dicarboxylic acid, or polycarboxylic acid; (2) dissolving the one or more alkyds, that optionally contains one or more tackifiers, and further optionally contains crosslinkable moieties, in a monomer mixture to form a polymer-in-monomer solution, wherein the monomer mixture contains one or more ethylenically unsaturated monomers; (3) combining with agitation, the polymer-in-monomer solution, that optionally contains one or more stabilizers, with at least one surfactant and a pH modifier dissolved in water to form a pre-emulsion; (4) agitating the pre-emulsion under high shear to form a mini-emulsion, the mini-emulsion containing an aqueous continuous phase and an organic disperse phase, the disperse phase being in the form of droplets having an average droplet diameter in the range of from about 10 to about 2000 nanometers measured by Dynamic Light Scattering; (5) adding one or more initiators to the mini-emulsion and activating the initiator(s) to polymerize the one or more ethylenically unsaturated monomers to form the core-shell polymer. A variety of initiators can be used, including photoinitiators, thermal initiators, and redox systems. In some embodiments, a redox system is used so that the free radical polymerization can be conducted at lower temperature, e.g., 60° C., to minimize the possible hydrolysis of the one or more alkyd.

As will be realized, the subject matter described herein is capable of other and different aspects and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic illustration of an example of a process for making an alkyd.

### DETAILED DESCRIPTION OF THE EMBODIMENTS

Of special interest to this present subject matter are water-dispersed compositions comprising core-shell polymer nano-size particles comprising one or more alkyd cores and (meth)acrylic polymer shells for use in biodegradable pressure sensitive adhesives.

### I. Definitions

“Alkyd”, as used herein, refers to a branched polyester oligomer or polymer synthesized by reacting one or more fatty acids, fatty acid esters, or combinations thereof with one or more polyols and one or more polycarboxylic acids. Additional monomers may be incorporated into the alkyd.

“Aliphatic” is defined as including alkyl, alkenyl, alkynyl, halogenated alkyl, and cycloalkyl groups as described above. A “lower aliphatic” group is a branched or unbranched aliphatic group having from 1 to 10 carbon atoms.

“Alkyl”, as used herein, refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl, and the like. As used herein a “lower alkyl” group is a saturated branched or unbranched hydrocarbon having from 1 to 10 carbon atoms. In some embodiments, alkyl groups have 1 to 4 carbon atoms may be used. Alkyl groups may be “substituted alkyls” wherein one or more hydrogen atoms are substituted with a substituent such as halogen, cycloalkyl, alkoxy, amino, hydroxyl, aryl, or carboxyl.

“Aqueous-based”, as used herein, refers to a solvent containing at least a portion of water, or mostly water. In certain embodiments the term “aqueous-based” may consist of water alone, water and dispersing agents alone, water and catalysts alone, or water and dispersing agents and catalysts. In certain embodiments, the term “aqueous based” may contain water, additives (e.g., catalyst, dispersing agents, etc.) and water-miscible co-solvents, such as alcohols or ketones. In accordance with certain embodiments, the aqueous-based continuous phase is devoid of co-solvents.

“Aryl”, as used herein, refers to any carbon-based aromatic group including, but not limited to, phenyl, naphthyl, and other suitable aryl compounds. As used herein the term “aryl” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorous. The aryl group may be substituted with one or more groups including, but not limited to, alkyl, alkynyl, alkenyl, aryl, halide, nitro, amino, ester, ketone, aldehyde, hydroxy, carboxylic acid, or alkoxy, or the aryl group may be unsubstituted.

“Bio-based”, as used herein, refers to renewable materials such as any naturally-occurring material or any naturally-occurring material that has been modified to include one or more reactive functional groups, in which the material may be suitable for use as a prepolymer for the ultimate formation of a PSA. In certain embodiments, the term “bio-based” may contain a variety of vegetable oils, functionally-modified vegetable oils, plant oils, functionally-modified plant oils, marine oils, functionally modified marine oils, or other ester of unsaturated fatty acids.

“Compostable”, as used herein, refers to a material that may be placed into a composition of decaying materials and eventually turns into a nutrient-rich material. In certain embodiments, the term “compostable” as used herein may include a plastic that undergoes degradation by biological processes during composting to yield carbon dioxide, water, inorganic compounds, and/or biomass via the action of naturally-occurring microorganisms, such as bacteria and fungi, at a rate consistent with other known compostable materials and that may leave no visible, distinguishable or toxic residue. In accordance with certain embodiments, the term “compostable” as used herein may include a material that completely breaks down and returns to nature, such as decomposing into elements found in nature within a reasonably short period of time after disposal, such as within one year. The breakdown of “compostable” adhesives, films, and labels as described herein may be carried out by microorganisms present within, for example, industrial composting facilities. Materials may be identified as “compostable” by pass/fail tests, developed by international standards organization ASTM International, including, for example, D5338 and D6400.

The terms “comprise(s),” “include(s),” “having,”, have”, “has,” “contain(s),” and variants thereof, are intended to be open-ended transitional phrases, terms, or words that do not preclude the possibility of additional acts or structure.

“Core-shell copolymer”, as used herein, refers to structured composite particles containing at least two different components, one at the center as, or in, the core and surrounded by the second as the shell. The two different components may be covalently or ionically bound or non-covalently and non-ionically associated.

“Cycloalkyl”, as used herein, refers to a non-aromatic carbon-based ring composed of at least three carbon atoms. Examples of cycloalkyl groups include, but are not limited to, cyclopropyl, cyclobutyl, cyclopentyl, cyclohexyl, and the like. As used herein the term “heterocycloalkyl group” is a cycloalkyl group as defined above in which at least one of the carbon atoms of the ring is substituted with a heteroatom such as, but not limited to, nitrogen, oxygen, sulfur, or phosphorous.

“Dispersion”, as used herein, refers a two-phase system where one phase contains discrete particulates, such as core-shell copolymers, distributed throughout a bulk substance, such as an aqueous-based phase, the particulates being the dispersed or internal phase while the bulk substance contains the continuous or external phase. The distribution of the dispersed phase may either be uniform or heterogeneous.

“Fatty acid”, as used herein, refers to molecules containing a long aliphatic chain terminated with a carboxylic acid group. In some embodiments, the aliphatic chain has from about 8 to about 30 carbons, from about 8 to about 24 carbons, or from 8 to about 22 carbons, or from about 8 to about 18 carbons. The aliphatic chain may be saturated or have one or more sites of unsaturation, e.g., double bonds.

“Fatty acid ester”, as used herein, refers to molecules containing a long aliphatic chain terminated with an ester group. In some embodiments, the aliphatic chain has from about 8 to about 30 carbons, or from about 8 to about 24 carbons, or from 8 to about 22 carbons, or from about 8 to about 18 carbons. The aliphatic chain may be saturated or have one or more sites of unsaturation, e.g., double bonds.

“Drying oils”, as used herein, refers to liquid oils (triglycerides) that cross-link and solidify by reaction with atmospheric oxygen. In order for this to happen, the fatty acid part of the triglyceride must contain at least two centers of unsaturation (double bonds) on one molecule chain. These double bonds may or may not be conjugated. Drying oils such as linseed, soybean, and safflower oils have cis-methylene-interrupted unsaturation. Other oils, such as tung oil, contain conjugated double bonds. Oils with an iodine number/value of over 150 are considered drying. Drying oils contain more than 50% of polyunsaturated acids. Not limiting examples of drying oils include linseed oil (IV 170-204), tung oil (IV 160-175), poppyseed oil (IV 140-158), perilla oil, soybean oil, safflower oil (IV 135-150), and walnut oil (IV 132-162).

“Non-drying oils”, as used herein, refers to oil that does not harden when it is exposed to air. Specifically, any vegetable or fish oil that does not dry or form a film, even on long exposure to air. Oils with an iodine number/value of less than 125 are considered non-drying. For example, peanut oil (IV 82-107) is more saturated than corn oil (IV 107-128), cottonseed (IV 100-115), or linseed (IV 170-204) oils; however, it is considerably less saturated than coconut (IV 6-11), palm (IV 49-55) or butter (IV 25-42) oils. Non-drying oils are primarily used in food products (coconut, corn, olive, etc.) but some are used as plasticizers with drying oils and with natural and synthetic resins. Non-limiting examples of non-drying oils include almond oil, babassu oil (IV 10-17), baobab oil (IV 76-78), peanut oil (IV 85-90), cocoa butter (IV 32-40), coconut oil (IV 6-11), macadamia nut oil (IV 74-76), pecan oil (IV 97-120), olive oil (IV 75-94), peanut oil (IV 82-107), pistachio (IV 86-101), and palm oil (IV 49-55).

When used to make alkyd compositions, both drying and semi-drying oils contain carbon-carbon double bonds that are capable of undergoing oxidative crosslinking, whereas non-drying oils either don't contain such bonds or don't contain a sufficient number of such bonds to effect cure.

“Iodine value (or iodine adsorption value or iodine number or iodine index, commonly abbreviated as IV)”, as used herein, in chemistry is the mass of iodine in grams that is consumed by 100 grams of a chemical substance. It is a measure of the relative degree of unsaturation in oil components, as determined by the uptake of halogen, Because the melting point and oxidative stability are related to the degree of unsaturation, IV provides an estimation of these quality factors. The greater the iodine value, the more unsaturation and the higher the susceptibility to oxidation. Iodine value helps to classify oils according to the degree of unsaturation into drying oils; having IV>150 (e.g., linseed, Lung), semi drying oils with IV 125-150 (e.g., soybean, sunflower), and non-drying oils with IV<125 (e.g., canola, olive, coconut). The iodine value is usually mentioned as a range in literature because the exact iodine value might vary from batch to batch and from harvest to harvest depending on the exact fatty acid profile of a given oil. Accepted international standards for determining IV include DIN 53241-1:1995-05, AOCS Method Cd 1-25, EN 14111, ISO 3961:2018, and ASTM D5554-15.

“Monounsaturated fatty acids (MUFA)”, as used herein, means a fatty acid or ester having only one unsaturated carbon-carbon bond (i.e., double-bond).

“Polyunsaturated fatty acids (PUFA)”, as used herein, means a fatty acid or ester having two or more unsaturated carbon-carbon bond (i.e., double-bonds).

“Heteroalkyl”, as used herein, means an alkyl group wherein at least one carbon atom of the otherwise alkyl backbone is replaced with a heteroatom, for example, 0, S or N.

“Liquid at room temperature”, as used herein, means a polymer that undergoes a degree of cold flow at room temperature. Cold flow is the distortion, deformation or dimensional change that takes place in materials under continuous load at temperatures within the working range. Cold flow is not due to heat softening.

“(Meth)acrylate copolymer”, as used herein, refers to polymers formed from monomers of acrylates and/or methacrylates or any combination of these in a polymer composition wherein the monomers are esters of acrylic acid or methacrylic acid containing a polymerizable ethylenic linkage. This term also includes other classes of monomers with ethylenic linkage that can copolymerize with acrylate and methacrylate monomers.

“Oligomer”, as used herein, refers to a compound containing one or more repeat units that has a weight average molecular weight (Mw) within a range of from about 300 to about 3,000 g/mole as determined by gel permeation chromatography (GPC).

“Polymer”, as used herein, refers to a compound containing a large number of repeat units that has a weight average molecular weight (Mw) greater than about 3,000 g/mole as determined by gel permeation chromatography (GPC). The term “polymer” encompasses homopolymers, copolymer, terpolymers, and the like unless otherwise indicated.

“Room temperature”, used herein, refers to temperatures within the range of from about 23° C. to about 25° C.

### II. Water-Dispersed Compositions

A. Core-Shell Polymers

The water-dispersed composition comprises or consists of core-shell polymer nano-sized particles, wherein the core comprises or consists of one or more alkyds and the shell comprises or consists of a (meth)acrylate polymer. The one or more alkyd may or may not be covalently bound to a shell containing one or more (meth)acrylate polymer. The (meth)acrylate copolymer shell encapsulates and protects the alkyd core from premature hydrolytic degradation thus improving the shelf-life of the aqueous dispersions.

The glass transition temperature (Tg) of the core-shell copolymer is from about −100° C. to about 50° C., or from about −100° C. to about 30° C., or from about −100° C. to about 10° C., or from about −100° C. to about −10° C. including all intermittent values and ranges therein, such as from about −70° C. to about 30° C., or from about −50° C. to about 0° C., or from about −40° C. to about −10° C. measured by differential scanning calorimetry (DSC).

1. Core

a. Alkyds

In some embodiments, the alkyd as defined or described above is prepared via the alcoholysis process. Generically, the alcoholysis process consists of reacting one mole of an oil (triglyceride) with 2 moles of a polyol (e.g., glycerol) at about 240° C. under base catalysis to form 3 moles of the monoglyceride. The monoglyceride is then cooled down and a dibasic acid (e.g., phthalic anhydride) is added. The mixture is reheated to 200-240° C. and esterified to an acid value typically below about 10 mg KOH/gram.

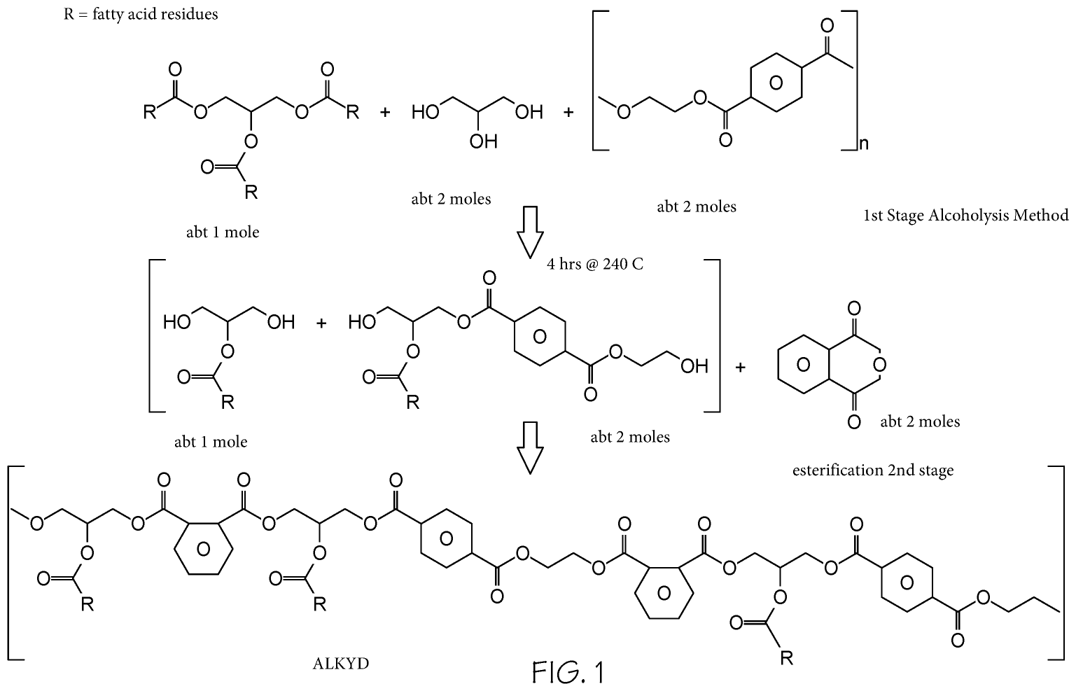

In some embodiments, the alkyd as defined or described above is prepared via a modified alcoholysis process, wherein the oil is mixed with a polyol and recycled PET (or other polyester based plastic to be recycled) and reacted at about 240° C. under base catalysis to form a mixture of oligomeric esters. A dibasic acid is then added and the mixture is reheated to 200-240° C. and esterified to an acid value typically below about 10 mg KOH/gram. Other high molecular weight polyester based plastics can also be used in this process as means of recycling them. Examples of other commercially produced polyesters that can be recycled in this way include polybutylene terephthalate (PBT), polybutylene adipate-co-terephthalate (PBAT), polylactic acid, the various polyhydroxy alkanoates (such as polyhydroxybutyrate and polyhydroxybutyrate-co-valerate), polybutylene succinate (PBS), polycaprolactone (PCL) and others. A schematic illustrating an example of a process for making an alkyd is shown in FIG. 1.

The one or more alkyds comprises one or more fatty acids and/or fatty acid esters covalently bound to a polyol. Alkyds are branched or highly branched structures depending on the number of the hydroxyl groups in the polyol. In some embodiments, the polyol has 3, 4, 5, 6 or more hydroxyl groups. The fatty acids and/or fatty acid esters are covalently bound to the polyol via the acid or ester group of the fatty acid and/or fatty acid ester and the hydroxyl groups of the polyol via ester linkages.

In a preferred embodiment, the one or more alkyd is prepared by the reaction of, or derived from, (i) a non-drying oil or non-drying oil fatty acids and/or esters, (ii) one or more mono-alcohol, dialcohol, or polyols, and (iii) one or more mono-carboxylic acid, dicarboxylic acid, or polycarboxylic acid.

The molecular weight of the alkyd can vary. In some embodiments, the weight average molecular weight of the alkyd is 1,000 g/mole to about 50,000 g/mole, including all intermittent values and ranges therein, such as from 5,000 g/mole to about 30,000 g/mole, and/or from about 10,000 g/mole to about 30,000 g/mole as determined by gel permeation chromatography (GPC). The alkyd preferably has a low glass transition temperature, for example, from about −100° C. to about 50° C., from about −100° C. to about 40° C., from about −100° C. to about 30° C., from about −100° C. to about 20° C., or from about −100° C. to about 10° C., or from about −100° C. to about −10° C., or from about −90° C. to about 30° C., or from about −80° C. to about 10° C., or from about −70° C. to about 0° C., or from about −60° C. to about −10° C.

i. Fatty Acids

The alkyd contains one or more fatty acids and/or fatty acid esters. In some embodiments, the alkyds contain the same polyol core and the same fatty acids and/or fatty acid esters. In some embodiments, the alkyds contain different polyol cores and the same fatty acids and/or fatty acid esters. In still other embodiments, the alkyds contain different polyol cores and different fatty acids and/or fatty acid esters. In some embodiments, the fatty acids and/or fatty acid esters contain from about 6 to about 30 carbon atoms, from about 8 to about 24 carbon atoms, or from about 8 to about 22 carbon atoms, or from about 8 to about 18 carbon atoms. In some embodiments, the fatty acids and/or fatty acid esters are as defined above and contain zero and one/or site of unsaturation (e.g., double bonds).

In some embodiments, alkyd is prepared by reaction of an oil, such as a vegetable, nut, or plant oil, which is typically a mixture of saturated and unsaturated fatty acids and/or fatty acid esters, with one or more polyols and one or more polycarboxylic acids to form the alkyd. Examples of oils include, but are not limited to, canola oil, corn oil, cottonseed oil, coconut oil, olive oil, safflower oil, soybean oil, sunflower oil, palm oil, walnut oil, almond oil, and sesame oil. In some embodiments, the alkyds are prepared from an oil that contains a high total concentration of saturated fatty acids and/or fatty acid esters and monounsaturated fatty acids and/or fatty acid esters and a low total concentration of polyunsaturated fatty acids and/or fatty acid esters. In some embodiments, the total concentration of polyunsaturated fatty acids and/or fatty acid esters is less than about 50%, or less than about 40%, or less than about 30%, or less than about 20%, or less than about 15%, or less than about 10%, or about 5%, or less than about 3%, or less than about 2.0%, or less than about 1.0%.

Examples of saturated fatty acids and/or esters include, but are not limited to, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, carboceric acid, montanic acid, nonacosylic acid, melissic acid, hentriacontylic acid, lacceroic acid, psyllic acid, geddic acid, ceroplastic acid, hexatriacontylic acid, heptatriacontylic acid, octatriacontylic acid, nonatriacontylic acid, and tetracontylic acid.

Examples of monounsaturated and polyunsaturated acids and/or esters include, but are not limited to, octenoic (8:1), decenoic (10:1), decadienoic (10:2), lauroleic (12:1), laurolinoleic (12:2), myristovaccenic (14:1), myristolinoleic (14:2), myristolinolenic (14:3), palmitolinolenic (16:3), palmitidonic (16:4), α-linolenic (18:3), stearidonic (18:4), dihomo-α-linolenic (20:3), eicosatetraenoic (20:4), eicosapentaenoic (20:5), clupanodonic (22:5), docosahexaenoic (22:6), 9,12,15,18,21-tetracosapentaenoic (24:5), 6,9,12,15,18,21-tetracosahexaenoic (24:6), myristoleic (14:1), palmitovaccenic (16:1), α-eleostearic (18:3), β-eleostearic (trans-18:3), punicic (18:3), 7,10,13-octadecatrienoic (18:3), 9,12,15-eicosatrienoic (20:3), β-eicosatetraenoic (20:4), 8-tetradecenoic (14:1), 12-octadecenoic (18:1), linoleic (18:2), linolelaidic (trans-18:2), γ-linolenic (18:3), calendic (18:3), pinolenic (18:3), dihomo-linoleic (20:2), dihomo-γ-linolenic (20:3), arachidonic (20:4), adrenic (22:4), osbond (22:5), palmitoleic (16:1), vaccenic (18:1), rumenic (18:2), paullinic (20:1), 7,10,13-eicosatrienoic (20:3), oleic (18:1), elaidic (trans-18:1), gondoic (20:1), erucic (22:1), nervonic (24:1), 8,11-eicosadienoic (20:2), mead (20:3), sapienic (16:1), gadoleic (20:1), 4-hexadecenoic (16:1), petroselinic (18:1), and 8-Eicosenoic (20:1).

In some embodiments, the fatty acid and/or fatty acid ester does not contain any epoxide functional groups.

ii. Alcohols, Glycols, and Polyols

Any polyol can be used to synthesize the alkyd. The number of hydroxyl groups determine the degree of branching in the alkyd. In some embodiments, the polyol has at least three hydroxyl groups. In some embodiments, the polyol has 3, 4, 5, or 6 hydroxyl groups. The polyol can be monomeric, oligomeric, and/or polymeric.

Examples of alcohols include methanol, ethanol, propanol, isopropanol, n-butanol, isobutanol, sec-butanol, tert-butanol, amyl alcohol, hexanol, 2-ethylhexanol, linear or branched fatty alcohols, and combinations thereof.

Examples of suitable glycols include, but are not limited to, ethylene glycol, diethylene glycol and its higher homologues, 1,2-propylene glycol, dipropylene glycol and its higher homologues, 1,3-propanediol, 2-methyl-1,3-propanediol, neopentyl glycol, trimethylpropanediol, 2-ethyl-2-butyl-1,3-propanediol, 1,4-butanediol and its higher homologues, 1,3-butylene glycol, 2,3-butanediol, 1,5-pentanediol, 3-methyl-1,5-pentanediol, hexanediol, dimer fatty diol, cyclohexanedimethanol, tricyclodecanedimethanol, 2,2,4,4-tetramethyl-1,3-cyclobutanediol, hydrogenated bisphenol A, isosorbide, glycerol, ethoxylated glycerol, propoxylated glycerol, trimethylolpropane, ethoxylated trimethylolpropane, propoxylated trimethylolpropane, trimethylolethane, pentaerythritol, dipentaerythritol, sugar alcohols, diglycerol, triglycerol, higher polyglycerols, and other polyhydroxy compounds resulting from the condensation of ketones or aldehydes with formaldehyde, and combinations thereof.

Examples of sugar alcohols include, but are not limited to, erythritol, lactitol, maltitol, mannitol, sorbitol, xylitol, and combinations thereof.

iii. Dicarboxylic and Polycarboxylic Acids

Dicarboxylic acids suitable for making alkyds include, but not limited to, oxalic acid, malonic acid, succinic acid or anhydride, glutaric acid, adipic acid, pimelic acid, suberic acid, azelaic acid, sebacic acid, dodecanedioc acid, dimer fatty acids, phthalic acid or anhydride, isophthalic acid, terephthalic acid, naphthalene dicarboxylic acid, tetrahydrophthalic anhydride, hexahydrophthalic anhydride, methylhexahydrophthalic anhydride, cyclohexane dicarboxylic acid, norbornene anhydride, furan dicarboxylic acid.

In some embodiments a small amount of α,β-unsaturated carboxylic acids may be used and include, but not limited to, maleic acid or anhydride, fumaric acid, itaconic acid, citraconic acid and mesaconic acid. In a preferred embodiment, maleic anhydride is added at the end of making the alkyd to provide terminal unsaturation. Other α,β unsaturated carboxylic acids or anhydrides that may be used for this purpose include, but not limited to, methacrylic anhydride, crotonic acid, sorbic acid, and fatty acids containing conjugated carbon-carbon double bonds such as α-eleostearic acid.

Poly functional carboxylic acids that may be used include, but not limited to, citric acid, trimer fatty acid, and trimellitic anhydride.

Substituted dicarboxylic acids include, but not limited to, malic acid, tartaric acid, aspartic acid, glutamic acid.

Hydroxy acids that may be used include, but not limited to, glycolic acid, lactic acid, the various hydroxy alkanoates such as hydroxybutyrate, hydroxyvalerate (and higher homologues), castor oil fatty acid, 12-hydroxystearic acid, the various lactones such as α-acetolactone, β-propiolactone, γ-butyrolactone, δ-valerolactone, ε-caprolactone or their hydrolyzed hydroxy acid derivatives.

iv. Polyesters

In some embodiments, the alkyd is prepared using a polyester, such as polyesters prepared by reacting a diol with a diacid and/or diester. Exemplary polyesters include, but are not limited to, polyethylene terephthalate, polybutylene terephthalate, polybutylene adipate terephthalate, polybutylene succinate, polycaprolactone, polylactic acid, the various polyhydroxy alkanoates such as polyhydroxy butyrate, polyhydroxy valerate, their higher molecular weight homologues and mixtures of these. In other embodiments, polycarbonate esters based on aliphatic glycols may also be incorporated into the alkyd, such as polyethylene carbonate, polypropylene carbonate, polybutylene carbonate, polyhexylene carbonate poly(2-ethyl-2-butyl-1,3-propylene) carbonate and the like. The polyester can be recycled or have recycled content. In some embodiments, the polyester is reacted with the oil (e.g., coconut oil), polyol (e.g., glycerol), polycarboxylic acid and esterification catalyst. The polyol transesterifies the polyester (chopping it into lower MW pieces) as well as transesterifying the oil (chopping the coconut oil).

v. Chain Extenders

In some embodiments, polyisocyanates may be used to chain extend the alkyd, (meth)acrylate polymer and/or core-shell polymer to form what are commonly referred to as uralkyds. Suitable isocyanates are hexamethylene diisocyanate along with dimers, trimers or oligomers derived from it; trimethyl hexamethylene diisocyanate; isophorone diisocyanate and its trimer; hydrogenated methylene diphenyl di-isocyanate (MDI); toluene diisocyanate and its trimer; MDI and its isomers along with polymeric MDI.

Another class of compounds that can be used to chain extend the alkyd, (meth)acrylate polymer and/or core-shell polymer are polyepoxides. Suitable polyepoxides are those based on polyphenolic compounds such as bisphenol F, bisphenol A, phenol formaldehyde novolacs, cresol formaldehyde novolacs. Another group of polyepoxides are those based on aliphatic glycols and polyols, such as ethylene glycol, butanediol, hexanediol, trimethylolpropane and the like.

vi. Crosslinker

The alkyds can optionally be covalently modified with one or more crosslinkers. The addition of crosslinkers allows the formation of polymer networks by crosslinking the core-shell polymer. In some embodiments, the crosslinker may be selected from the group consisting of polyaziridines, polyisocyanates, polyepoxides, polycarbodiimides, dianhydride, a polyfunctional monomer, and combinations thereof.

In some embodiments, the crosslinker is a dianhydride. Examples of suitable dianhydrides includes, but are not limited to, ethylene glycol bis(trimellitate), pyromellitic dianhydride (PMDA); 4,4′-oxydiphthalic anhydride (ODPA); hexafluoroisopropylidene-bis-phthalic dianhydride (6-FDA); and 3,3′,4,4′-benzophenonetetracarboxylic dianhydride (BTDA), bisphenol-A dianhydride (BisDA) and cyclobutane-1,2,3,4-tetracarboxylic dianhydride.

2. Shell

a. (Meth)Acrylate Polymers

The shell contains one or more (meth)acrylate polymer (e.g., homopolymers, copolymers, terpolymers, etc.). The one or more (meth)acrylate polymers may or may not be covalently bound to one or more alkyds, which form the core. In some embodiments, the (meth)acrylate polymers are grafted to the alkyd via free radical polymerization of the (meth)acrylate monomer initiated by one or more double bonds in the fatty acid chain(s) of the alkyd. Suitable (meth)acrylate polymers include, but are not limited to, polymers derived from acrylates, methacrylates, or mixtures thereof. The (meth)acrylate polymer is derived from acrylic acid or acrylates comprising Cl to about C20 alkyl acrylates, methacrylic acid or methacrylates comprising C4 to about C20 alkyl methacrylates, or mixtures thereof such as acrylic acid, methyl acrylate, ethyl acrylate, n-butyl acrylate, iso-butyl acrylate, n-hexyl acrylate, n-heptyl acrylate, n-octyl acrylate, isooctyl acrylate, 2-ethylhexyl acrylate, n-nonyl acrylate, isodecyl acrylate, 2-propyl heptyl acrylate, lauryl acrylate, isostearyl acrylate, β-carboxyethyl acrylate, hydroxyethyl acrylate, hydroxypropyl acrylate, hydroxybutyl acrylate, ethoxyethoxyethyl acrylate, methacrylic acid, n-butyl methacrylate, iso-butyl methacrylate, n-hexyl methacrylate, n-heptyl methacrylate, n-octyl methacrylate, isooctyl methacrylate, 2-ethylhexyl methacrylate, n-nonyl methacrylate, isodecyl methacrylate, 2-propyl heptyl methacrylate, lauryl methacrylate, isostearyl methacrylate, hydroxyethyl methacrylate, hydroxypropyl methacrylate, hydroxybutyl methacrylate, ethoxyethoxyethyl methacrylate, and combinations thereof.

b. Photoinitiators

The (meth)acrylate polymer may contain one or more photoinitiators. The photoinitiator may be covalently bound to the (meth)acrylate polymer backbone and/or side chains. In other embodiments, the (meth)acrylate polymer backbone and/or side chains contain a chemical moiety that can be converted to a photoinitiator in-situ. In some embodiments, the photoinitiator is selected from acetophenone, an acetophenone derivative, benzophenone, a benzophenone derivative (e.g., hydroxylated or alkoxylated), anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof. In some embodiments, photoinitiator is activatable upon exposure to UV radiation to at least partially polymerize and/or crosslink the (meth)acrylate polymers, e.g., before or after (meth)acrylate polymer is grafted to the alkyd to form the core-shell polymer.

B. Additives

The water dispersed composition can contain one or more additives. Exemplary classes of additives include, but are not limited to, pigments, fillers, plasticizers, diluents, antioxidants, tackifiers, crosslinkers, chain extenders, and combinations thereof.

C. Crosslinking

The pressure sensitive adhesive may be crosslinked during the drying of the adhesive to increase the cohesive strength of the pressure sensitive adhesive. This can be achieved via covalent crosslinking using heat, actinic or electron beam radiation, or metal based ionic crosslinking between functional groups. Table 1 below lists the types of crosslinkers for the various functional groups of the segmented polymer.

TABLE 1
Possible Crosslinkers for Polymers

| Functional Group | |
|---|---|
| of Polymer | Crosslinker |
| Silane | Self-reactive |
| Hydroxyl | Isocyanate, Melamine Formaldehyde, Dianhydride, |
| Carboxylic acid | Epoxy, Carboiimides, Metal Chelates, and Oxazolines |
| Epoxy | Amine, Carboxylic acid, Phosphoric acid, Mercaptan |
| Mercapto | Isocyanate, Melamine formaldehyde, Anhydride, |
| | Epoxy |
| Acetoacetate | Acrylate, Amine, Isocyanates, Metal Chelates |

### III. Methods of Making the Water-Dispersed Compositions

Methods of making the water-dispersed compositions are also described herein. In some embodiments, the method of making the water-dispersed compositions include preparing an alkyd by reacting one or more fatty acids and/or esters or a mixture thereof, such as in the form of an oil, with one or more polyols and one or more polycarboxylic acids to form the alkyd. The alkyd can further be functionalized with one or more chain extenders or crosslinkers.

Methods of making the water-dispersed compositions are also described herein. In some embodiments, the method of making the water-dispersed compositions include the steps of (1) providing the one or more alkyd prepared by reacting (i) a non-drying oil or non-drying oil fatty acids and/or esters, (ii) one or more mono-alcohol, dialcohol, or polyols, and (iii) one or more mono-carboxylic acid, dicarboxylic acid, or polycarboxylic acid; (2) dissolving the one or more alkyds, that optionally contains one or more crosslinkable moieties, in a monomer mixture to form a polymer-in-monomer solution, wherein the monomer mixture contains one or more ethylenically unsaturated monomers; (3) combining with agitation, the polymer-in-monomer solution, that optionally contains one or more stabilizers, with at least one surfactant and a pH modifier dissolved in water to form a pre-emulsion; (4) agitating the pre-emulsion under high shear to form a mini-emulsion, the mini-emulsion containing an aqueous continuous phase and an organic disperse phase, the disperse phase being in the form of droplets having an average droplet diameter in the range of from about 10 to about 2000 nanometers, or about 50 nm to about 600 nm or about 100 nm to about 400 nm, or about 200 nm to about 400 nm, measured by Dynamic Light Scattering; (5) adding one or more initiators to the mini-emulsion and activating the initiator(s) to polymerize the one or more ethylenically unsaturated monomers to form the core-shell polymer. A variety of initiators can be used, including photoinitiators, thermal initiators, and redox systems. In some embodiments, a redox system is used so that the free radical polymerization can be conducted at lower temperature, e.g., 60° C., to minimize the possible hydrolysis of the one or more alkyd.

In some embodiments, the monomer mixture and/or the mini-emulsion optionally contains one or more tackifiers. In a preferred embodiment, the one or more tackifier is also dissolved into the alkyd/ethylenically unsaturated monomers solution which is then converted into a mini-emulsion and polymerized. A particular benefit of this embodiment is that the tackifier(s) is uniformly distributed throughout the adhesive film compared to making an emulsion PSA and later blending in pre-dispersed tackifier(s). A PSA emulsion of this second process has the polymer contained within its nanometer (50-600 nm) sized particles while the tackifier(s) is contained within its own micron sized particles. Post blending a pre-dispersed tackifier(s) into a PSA emulsion leads to a non-uniform adhesive film with PSA properties inferior to the homogeneous mixture. The miniemulsion monomer droplet dispersion particle size distribution measurements were measured by dynamic light scattering, for example, using a Nicomp particle sizer, model 370.

In some embodiments, the polymer-in-monomer solution further contains a photoinitiator moiety. In other embodiments, the polymer-in-monomer solution contains a monomer containing a photoinitiator moiety. Representative and non-limiting examples of the photoinitiator moiety include those selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

In some embodiments, the core-shell polymer is prepared using emulsion polymerization. In some embodiment, the emulsion is a mini-emulsion. The use of a mini-emulsion allows the preparation of stable nano-sized droplets of the alkyd-monomer in an aqueous dispersion. These nano-sized monomer droplets are efficiently converted to polymer particles via the use of one or more initiators, such as thermal initiators, photo initiators, and/or redox systems. The initiator may be dissolved within the monomer mixture prior to forming the mini-emulsion or it may be added as an aqueous solution to the aqueous phase. Using the appropriate concentration of initiator, the nano-sized alkyd-monomer droplets are converted to nano-sized polymer particles as they begin to polymerize from the outset. The overwhelmingly large polymer particle surface area provided by the nano-sized polymer particles of the present subject matter effectively absorb monomer from the water phase when it comes to time to replenish the monomer. This means that initial monomer droplets are needed which have diameters typically less than about 500 nm and in certain embodiments, less than 300 nm. Although diameters less than about 500 nm are used in many embodiments, it is contemplated that in certain applications, larger particles could be used such as up to about 2,000 nm. When stable nano-sized alkyd-monomer droplets are achieved, they can be readily converted to stable nano-sized polymer droplets by activating the initiator to cause the polymerization reaction to occur. Ideally, all the alkyd-monomer droplets are transformed to polymer particles.

A difference between standard monomer emulsion and a mini-emulsion process is the use of high energy mixing, i.e., high shear mixing and one or more co-stabilizer(s) to create mini-emulsion nano-dispersions. High shear mixing provides the means to violently rip micron-sized monomer droplets apart. The micron-sized droplets can be reduced to nano-sized droplets using high shear mixing. However, without co-stabilizer added to the monomer phase, those monomer nano-droplets quickly “Ostwald ripen” back to micron sized particles. Ostwald ripening is a process in which monomer diffuses from nano-sized droplets to micron sized and larger droplets. It is a thermodynamically driven process. There is a high energy cost in maintaining small droplets, where there is very large surface area to volume ratios. It is energetically favorable for the sparingly soluble monomers to exist as much larger particles.

In a typical mini-emulsion process, a co-stabilizer is required to form a stable mini-emulsion. Co-stabilizers are extremely hydrophobic compounds that are soluble in hydrophobic acrylic monomers. Exemplary co-stabilizers include, but are not limited to, hexadecane or other small molecule, water insoluble solvents. The concentration of the co-stabilizer is typically about 5% by weight based on monomer. It has been found, however, that the alkyd, because of its hydrophobic nature, behaves as a co-stabilizer for the mini-emulsion process and a separate co-stabilizer is typically not necessary.

The methods described herein can also utilize one or more copolymerizable co-stabilizer(s). A non-limiting example of such a stabilizer is heptadecyl acrylate, an acrylate with 17 carbons that is a sufficiently small molecule and is highly water insoluble. The small size contributes to its required mobility as a co-stabilizer. This co-stabilizer is a reactive acrylate with a low glass transition temperature (Tg). As a reactive acrylate, heptadecyl acrylate readily copolymerizes with the monomers employed and its low glass transition temperature and hydrophobic nature makes it a useful component monomer for constructing polymers used in PSAs. This co-stabilizer is also liquid at ambient temperature which makes it easy to handle at production scale. It will be understood that other polymerizable co-stabilizers can be used.

The polymer mini-emulsion formed above contains the core-shell copolymer, the core containing the alkyd and the shell containing a (meth)acrylate copolymer. The (meth)acrylate copolymer being formed by the copolymerization of the monomer mixture and the alkyd and the core-shell copolymer being the reaction product of the alkyd and the (meth)acrylate copolymer. In the core-shell copolymers contemplated herein, the alkyd is from about 5% to about 95% by weight of the core-shell polymer(s) and the weight ratio of the alkyd to the (meth)acrylate copolymer is within the range of from about 5:95 to about 95:5 of the core-shell copolymer, including all intermittent values and ranges therein, preferably within the range of from about 50:50 to about 95:5 of the core-shell copolymer, and most preferably within the range of from about 70:30 to about 95:5 of the core-shell copolymer.

In embodiments whereby a photoinitiator moiety is added into the polymer-in-monomer solution, the polymerization of the mini-emulsion generates a (meth)acrylate copolymer containing a photoinitiator moiety in the form of a distinct agent that is added to the composition, or a photoinitiator moiety bound to the copolymer backbone, or a photoinitiator moiety formed in-situ by an association of materials or agents in the composition. In such embodiments, the photoinitiator is activatable upon exposure to UV radiation to further polymerize and/or crosslink the core-shell copolymer.

Representative and non-limiting examples of ranges of the glass transition temperature (Tg) of the (meth)acrylate polymer described herein is from about −100° C. to about 50° C., including all intermittent values and ranges therein, such as from about −70° C. to about 30° C., or from about −50° C. to about 0° C., or from about −40° C. to about −10° C. measured by differential scanning calorimetry (DSC).

### IV. Applications

The core-shell copolymers and compositions containing the same described herein can be used for a variety of application. In some embodiments, the copolymers and/or compositions containing the same are used as adhesives or in adhesive compositions. In some embodiments, the core-shell copolymers described herein and compositions described herein can be used as pressure sensitive adhesives (PSAs) or in PSA compositions.

A widely acceptable quantitative description of a pressure sensitive adhesive (PSA) is given by the Dahlquist criterion, which indicates that materials having an elastic modulus (G′) of less than 3×10⁶ dynes/cm² (i.e., 3×10⁵ Pa) on a 1-s time scale at the test temperature have PSA properties while materials having a G′ in excess of this value do not. Empirically, it was found that materials that exhibit pressure sensitivity are those that are sufficiently soft, exhibiting an elastic modulus of less than 3×10⁵ Pa (3×10⁶ dyn/cm²) on a 1-s time scale at the test temperature. This somewhat surprising but well accepted empirical criterion was first established by Dahlquist and is commonly referred as the “Dahlquist criterion”. The pressure sensitive adhesive contemplated herein exhibits a plateau shear modulus at 25° C. and 1 radian per second that is between 5×10⁴ and 6×10⁶ dynes/cm² as determined by dynamic mechanical analysis (DMA).

In some embodiments, the glass transition temperature (Tg) of the pressure sensitive adhesive is from about −100° C. to about 20° C., including all intermittent values and ranges therein, such as from about −100° C. to about 10° C., or about −100° C. to about 0° C., or about −100° C. to about −10° C. or about, or about −70° C. to about 30° C., or from about −50° C. to about 0° C., or from about −40° C. to about −10° C. measured by differential scanning calorimetry (DSC).

The aqueous-based dispersions described herein provide an improvement in handling and application or deposition onto a variety of substrates, such as for making a PSA construct. This improvement in handling and application may be due, at least in part, to the relatively low viscosity of the aqueous-based dispersions according to embodiments of the present invention as compared to traditional warm/hot melt adhesives. For instance, the viscosity of the aqueous-based dispersions according to certain embodiments may be from about 5 to about 1500 centipoise (Cp) at 20° C. or from about 5 to about 500 Cp at 20° C. as measured using a rotational viscometer. The relatively low viscosities of the aqueous-based dispersions according to certain embodiments ensure easier and more complete or thorough coating/coverage of a substrate for preparation of PSA constructs, such as adhesive articles. The aqueous-based dispersions described herein provide an improvement in the sustainability of pressure sensitive adhesives and constructions. PET and other commercially produced polyester plastics can be diverted from landfills by being recycled into a PSA composition that, at the end of its intended use, will naturally biodegrade in the environment and provide useful compost material.

Method of manufacturing PSA constructs are also described. Methods may include applying an aqueous-based dispersion described herein onto a backing substrate and drying the aqueous-based dispersion. The aqueous-based dispersion may be thermally dried by simply heating the dispersion and/or PSA construct. For instance, the drying step may include heating the applied dispersion and/or PSA construct to drive-off, such as by evaporation or otherwise, the continuous aqueous-based phase.

Backing substrates are not particularly limited by type of construction. For example, backing substrates may include paper, cellophane, plastic film, such as, for example, bi-axially oriented polypropylene (BOPP) film, polyvinylchloride (PVC) film, cloth, tape, or metal foils. In some embodiments, the plastic film is itself a biodegradable composition allowing the entire PSA construct to biodegrade in the environment.

### EXAMPLES

In order to further illustrate aspects of the present subject matter, the following examples are provided. The following examples are intended only to illustrate methods and aspects in accordance with the present subject matter, and as such should not be construed as imposing limitations upon the claims.

### Example 1—Alkyd Resin

Into a 2-liter glass reaction vessel was charged 651.3 grams of coconut oil, 220.3 gm glycerol, 459.7 grams recycled PET flakes, and 1.6 grams of monobutyltin tris(2-ethylhexanoate). Under nitrogen blanket with stirring, the contents were heated to 240° C. and held at this temperature for 4-hours until all the coconut oil and PET flakes were transesterified by glycerol into a clear, homogeneous mixture. The contents were then cooled to 160° C., at which point 332.1 grams of adipic acid were charged into the reactor. A Dean-Stark trap, filled with heptane, was set up on top of the reactor to collect water from the esterification reaction. The reactor contents were then gradually heated up to 220° C. and esterified to an acid value of 6.8 mg KOH/gram, with 85 ml of water collected. Residual heptane was stripped off and then the reactor contents were cooled to 120° C. The nitrogen sparge was replaced with a dry air sparge into the resin and 0.8 grams butylated hydroxytoluene (BHT) and 18.4 grams of methacrylic anhydride were charged to the reactor and held for 2 hours to provide an alkyd resin with a small amount of methacrylate functionality for grafting with acrylic monomer. The neat resin had a viscosity of 124K centipoise (cps), number average molecular weight (Mn) of 2,047, weight average molecular weight (Mw) of 15,634 and polydispersity (PD) of 7.64.

### Example 2—Alkyd Resin

Into a 2-liter glass reaction vessel was charged 526.3 grams of coconut oil, 178.0 gm glycerol, 371.5 grams recycled PET flakes, and 1.6 grams of monobutyltin tris(2-ethylhexanoate). Under nitrogen blanket with stirring, the contents were heated to 240° C. and held at this temperature for 4-hours until all the coconut oil and PET flakes were transesterified by glycerol into a clear, homogeneous mixture. The contents were then cooled to 160° C., at which point 305.1 grams of isophthalic acid and 272.8 grams of oleic acid were charged into the reactor. A Dean-Stark trap, filled with heptane, was set up on top of the reactor to collect water from the esterification reaction. The reactor contents were then gradually heated up to 220° C. and esterified to an acid value of 5.6 mg KOH/gram. Residual heptane was stripped off and then the reactor contents were cooled to 120° C. The nitrogen sparge was replaced with a dry air sparge into the resin and 0.4 grams BHT and 29.8 grams of methacrylic anhydride were charged to the reactor and held for 2 hours to provide an alkyd resin with a small amount of methacrylate functionality for grafting with acrylic monomer. The neat resin had a viscosity of 1.24M cps, Mn of 2,535, Mw of 16,103 and PD of 6.35.

### Example 3—Alkyd Resin

Into a 2-liter glass reaction vessel was charged 621.9 grams of coconut oil, 210.4 gm glycerol, 439.0 grams recycled PET flakes, and 1.6 grams of monobutyltin tris(2-ethylhexanoate). Under nitrogen blanket with stirring, the contents were heated to 240° C. and held at this temperature for 4-hours until all the coconut oil and PET flakes were transesterified by glycerol into a clear, homogeneous mixture. The contents were then cooled to 160° C., at which point 321.5 grams of phthalic anhydride was charged into the reactor. A Dean-Stark trap, filled with heptane, was set up on top of the reactor to collect water from the esterification reaction. The reactor contents were then gradually heated up to 220° C. and esterified to an acid value of 6.3 mg KOH/gram. Residual heptane was stripped off and then the reactor contents were cooled to 120° C. and 44.8 grams of maleic anhydride was charged to the reactor and held for 1-hour to provide an alkyd resin with a small amount of unsaturation for grafting with acrylic monomer. The neat resin had a Mn of 1,770, Mw of 9,913 and PD of 5.60.

### Example 4—Alkyd Resin

Into a 2-liter glass reaction vessel was charged 617.5 grams of coconut oil, 208.9 gm glycerol, 435.9 grams recycled PET flakes, and 1.6 grams of monobutyltin tris(2-ethylhexanoate). Under nitrogen blanket with stirring, the contents were heated to 240° C. and held at this temperature for 4-hours until all the coconut oil and PET flakes were transesterified by glycerol into a clear, homogeneous mixture. The contents were then cooled to 160° C., at which point 370.9 grams of cyclohexane dicarboxylic acid was charged into the reactor. A Dean-Stark trap, filled with heptane, was set up on top of the reactor to collect water from the esterification reaction. The reactor contents were then gradually heated up to 220° C. and esterified to an acid value of 7.7 mg KOH/gram. Residual heptane was stripped off and then the reactor contents were cooled to 120° C. 44.5 grams of maleic anhydride was then charged to the reactor and held for 1-hour to provide an alkyd resin with a small amount of unsaturation for grafting with acrylic monomer. The neat resin had a Mn of 3,101, Mw of 58,554 and PD of 18.88.

### Example 5—Alkyd Resin

Into a 2-liter glass reaction vessel was charged 600.4 grams of coconut oil, 203.1 gm glycerol and 1.6 grams of monobutyltin tris(2-ethylhexanoate). Under nitrogen blanket with stirring, the contents were heated to 240° C. and held at this temperature for 4-hours until the coconut oil was completely transesterified by glycerol. The contents were then cooled to 160° C., at which point 167.8 grams of propylene glycol and 740.4 grams of cyclohexane dicarboxylic acid were charged into the reactor. A packed column was set up on top of the reactor to separate glycol from water as the reactor contents were gradually heated up to 220° C. When the overhead temperature dropped to 94° C., the column was replaced with a Dean-Stark trap, filled with heptane, and the esterification reaction was continued to an acid value of 4.9 mg KOH/gram. Residual heptane was stripped off and then the reactor contents were cooled to 120° C. and 43.3 grams of maleic anhydride was charged to the reactor and held for 1-hour to provide an alkyd resin with a small amount of unsaturation for grafting with acrylic monomer. The neat resin had a Mn of 1,788, Mw of 15,173 and PD of 8.49.

### Example 6—Alkyd Resin

Into a 2-liter glass reaction vessel was charged 526.6 grams of coconut oil, 259.3 gm trimethylolpropane and 1.6 grams of monobutyltin tris(2-ethylhexanoate). Under nitrogen blanket with stirring, the contents were heated to 240° C. and held at this temperature for 4-hours until the coconut oil was completely transesterified. The contents were then cooled to 160° C., at which point 282.5 grams of trimethylpentanediol and 648.9 grams of cyclohexane dicarboxylic acid were charged into the reactor. A packed column was set up on top of the reactor to separate glycol from water as the reactor contents were gradually heated up to 220° C. When the overhead temperature dropped to 95° C., the column was replaced with a Dean-Stark trap, filled with heptane, and the esterification reaction was continued to an acid value of 6.7 mg KOH/gram. Residual heptane was stripped off and then the reactor contents were cooled to 120° C. and 19.0 grams of maleic anhydride was charged to the reactor and held for 1-hour to provide an alkyd resin with a small amount of unsaturation for grafting with acrylic monomer. The neat resin had a Mn of 2,296, Mw of 22,045 and PD of 9.60.

### Example 7—Tackifier Resin

Into a 2-liter glass reaction vessel was charged 731.9 grams trimethylpentanediol, 718.5 gm cyclohexane dicarboxylic acid and 1.3 grams of monobutyltin tris(2-ethylhexanoate). A packed column was set up on top of the reactor to separate glycol from water as the reactor contents were gradually heated up to 215° C. under a nitrogen blanket. When the overhead temperature dropped to 92° C., the column was replaced with a Dean-Stark trap, filled with heptane, and the esterification reaction was continued to an acid value of 14.8 mg KOH/gram. Residual heptane was stripped off and then the reactor contents were cooled to 120° C. The nitrogen sparge was replaced with a dry air sparge into the resin and 0.26 grams BHT and 325.3 grams of butyl acrylate were charged to the reactor and cooled to room temperature. The tackifier resin solution had a viscosity of 685 cps, a Mn of 1,733, Mw of 3,241 and PD of 1.87.

### Example 8—Tackifier Resin

Into a 2-liter glass reaction vessel was charged 254.1 grams of propylene glycol, 488.1 grams trimethylpentanediol, 958.4 gm cyclohexane dicarboxylic acid and 1.5 grams of monobutyltin tris(2-ethylhexanoate). A packed column was set up on top of the reactor to separate glycol from water as the reactor contents were gradually heated up to 200° C. under a nitrogen blanket. When the overhead temperature dropped, the column was replaced with a Dean-Stark trap, filled with heptane, and the esterification reaction was continued to an acid value of 15.5 mg KOH/gram. Residual heptane was stripped off and then the reactor contents were cooled to 120° C. The nitrogen sparge was replaced with a dry air sparge into the resin and 0.5 grams BHT and 375.0 grams of butyl acrylate were charged to the reactor and cooled to room temperature. The tackifier resin solution had a viscosity of 3,285 cps, a Mn of 1,715, Mw of 3,091 and PD of 1.76.

### Example 9—Acrylic Modified Alkyd

The alkyd of example 1 (714.0 grams) was dissolved in 163.2 grams of butyl acrylate, 102.0 grams of methyl acrylate, 20.4 grams of acrylic acid, 20.4 grams of methacrylic acid and 76.5 grams of isopropanol. The alkyd solution was then poured slowly under high speed mixing into a mixture containing 551.8 grams of water, 153.0 grams Maxemul 6112/20N (surfactant) and 10.2 grams of ammonia (19% solution in water) to form a pre-emulsion. The pre-emulsion was then run through a high shear homogenizer (2 sequential passes) to form a stable mini-emulsion. Next, 155.8 grams of the mini-emulsion is then added to a 2-liter, water jacketed, glass reactor along with 145.4 grams of water. The jacket temperature was set for 60° C. and the reactor contents heated up for about 30 minutes. While the mixture was heating up, a first peroxide mixture was made up from 0.05 grams of tert-butyl hydroperoxide (70% in water) and 0.53 grams of water. Likewise, a first reducing agent solution was made up from 0.05 grams of Bruggolite FF6 and 0.53 grams of water. Then a second peroxide mixture was made up from 0.56 grams of tert-butyl hydroperoxide (70%) and 61.20 grams of water. Likewise, a second reducing agent solution was made up from 0.56 grams of Bruggolite FF6 and 61.20 grams of water. After 30 minutes of heating, the reactor contents reached a temperature of 54° C. and the first peroxide solution and the first reducing agent solution were charged to the reactor. The reactor contents exothermed to a peak temperature of 57° C. over a time of about 15 minutes and were allowed to continue reacting for another 15 minutes. After this hold period, the remainder of the mini-emulsion (1655.7 grams) was fed into the reactor over a period of 3 hours. Simultaneously, the second peroxide solution and the second reducing agent solution were each individually fed into the reactor over a 4-hour time period. When the mini-emulsion feed was finished (3 hours), the pump was flushed with 30.6 grams of water and the reactor temperature was noted to be 58° C. After the redox feed was completed (4-hours) the reactor temperature was noted to be 59° C. and allowed to continue reacting for another hour. During this 1-hour hold period, a third peroxide mixture was made up from 0.92 grams of tert-butyl hydroperoxide (70%) and 20.40 grams of water. Likewise, a third reducing agent solution was made up from 0.92 grams of Bruggolite FF6 and 20.40 grams of water. After the 1-hour hold, the temperature was noted to be 58° C., and the third peroxide solution and the third reducing agent solution were fed into the reactor over a 1-hour time period. After the 1-hour feed was finished, the reactor contents were allowed to continue reacting for another hour before cooling down to room temperature and being discharged from the reactor. The liquid properties and molecular weight of this acrylic modified alkyd mini-emulsion can be found in Table 2.

### Example 10—Acrylic Modified Alkyd

The formulation and process of Example 9 was repeated except that 714.0 grams of the alkyd from Example 2 was used instead of the alkyd from Example 1 and 76.5 grams of acetone was used instead of isopropanol. The liquid properties and molecular weight of this acrylic modified alkyd mini-emulsion can be found in Table 2.

### Example 11-Acrylic Modified Alkyd with Tackifier

The alkyd of example 6 (459.0 grams) was dissolved in 99.5 grams of butyl acrylate, 102.0 grams of methyl acrylate, 20.4 grams of acrylic acid, 20.4 grams of methacrylic acid, 318.8 grams of the tackifier solution of Example 7 and 76.5 grams of acetone. The alkyd solution was then poured slowly under high speed mixing into a mixture containing 524.8 grams of water, 178.5 grams Maxemul 6112/20N (surfactant) and 20.4 grams of ammonia (19% solution in water) to form a pre-emulsion. The pre-emulsion was then run through a high shear homogenizer (2 sequential passes) to form a stable mini-emulsion. Next, 255.0 grams of water was added to a 2-liter, water jacketed, glass reactor and the jacket temperature was set for 60° C. While the mixture was heating up, a first peroxide mixture was made up from 0.61 grams of tert-butyl hydroperoxide (70% in water) and 61.20 grams of water. Likewise, a first reducing agent solution was made up from 0.61 grams of Bruggolite FF6 and 61.20 grams of water. After 35 minutes of heating, the reactor contents reached a temperature of 52° C. and the mini-emulsion (1820.2 grams) was fed into the reactor over a period of 3 hours. Simultaneously, the first peroxide solution and the first reducing agent solution were each individually fed into the reactor over a 4-hour time period. When the mini-emulsion feed was finished (3 hours), the pump was flushed with 30.6 grams of water and the reactor temperature was noted to be 58° C. After the redox feed was completed (4-hours) the reactor temperature was noted to be 58° C. and allowed to continue reacting for another hour. During this 1-hour hold period, a second peroxide mixture was made up from 0.92 grams of tert-butyl hydroperoxide (70%) and 20.40 grams of water. Likewise, a second reducing agent solution was made up from 0.92 grams of Bruggolite FF6 and 20.40 grams of water. After the 1-hour hold, the temperature was noted to be 57° C., and the second peroxide solution and the second reducing agent solution were fed into the reactor over a 1-hour time period. After the 1-hour feed was finished, the reactor contents were allowed to continue reacting for another hour before cooling down to room temperature and being discharged from the reactor. The liquid properties and molecular weight of this acrylic modified alkyd mini-emulsion can be found in Table 2.

### Example 12-Acrylic Modified Alkyd with Tackifier

The formulation and process of Example 11 was repeated except that 408.0 grams of the alkyd from Example 5 was used instead of the alkyd from Example 6; 382.5 grams of the tackifier solution of Example 8 was used instead of Example 7 and 86.7 grams of butyl acrylate instead of 99.5 grams. The liquid properties and molecular weight of this acrylic modified alkyd mini-emulsion can be found in Table 2.

### Example 13-Acrylic Modified Alkyd

The alkyd of example 3 (612.0 grams) was dissolved in 224.4 grams of butyl acrylate, 142.8 grams of methyl acrylate, 20.4 grams of acrylic acid and 20.4 grams of methacrylic acid. The alkyd solution was then poured slowly under high speed mixing into a mixture containing 567.3 grams of water, 153.0 grams Maxemul 6112/20N (surfactant) and 10.2 grams of ammonia (19% solution in water) to form a pre-emulsion. The pre-emulsion was then run through a high shear homogenizer (2 sequential passes) to form a stable mini-emulsion. Next, 255.0 grams of water was added to a 2-liter, water jacketed, glass reactor and the jacket temperature was set for 60° C. While the mixture was heating up, a first peroxide mixture was made up from 0.82 grams of tert-butyl hydroperoxide (70% in water) and 61.20 grams of water. Likewise, a first reducing agent solution was made up from 0.82 grams of Bruggolite FF6 and 61.20 grams of water. After about 30 minutes of heating, the reactor contents reached a temperature of 52° C. and the mini-emulsion (1743.7 grams) was fed into the reactor over a period of 3 hours. Simultaneously, the first peroxide solution and the first reducing agent solution were each individually fed into the reactor over a 4-hour time period. When the mini-emulsion feed was finished (3 hours), the pump was flushed with 30.6 grams of water and the reactor temperature was noted to be 59° C. After the redox feed was completed (4-hours) the reactor temperature was noted to be 58° C. and allowed to continue reacting for another hour. During this 1-hour hold period, a second peroxide mixture was made up from 1.22 grams of tert-butyl hydroperoxide (70%) and 20.40 grams of water. Likewise, a second reducing agent solution was made up from 1.22 grams of Bruggolite FF6 and 20.40 grams of water. After the 1-hour hold, the temperature was noted to be 57° C., and the second peroxide solution and the second reducing agent solution were fed into the reactor over a 1-hour time period. After the 1-hour feed was finished, the reactor contents were allowed to continue reacting for another hour before cooling down to room temperature and being discharged from the reactor. The liquid properties and molecular weight of this acrylic modified alkyd mini-emulsion can be found in Table 2.

### Example 14—Acrylic Modified Alkyd

The formulation and process of Example 13 was repeated except that 612.0 grams of the alkyd from Example 4 was used instead of the alkyd from Example 3. The liquid properties and molecular weight of this acrylic modified alkyd mini-emulsion can be found in Table 2.

TABLE 2
Mini-emulsion Liquid Properties and Acrylic Modified Alkyd Molecular Weights

| | Example 9 | Example 10 | Example 11 | Example 12 | Example 13 | Example 14 |
|---|---|---|---|---|---|---|
| Non-Volatiles (%) | 48.1 | 48.7 | 45.9 | 45.8 | 47 | 46.5 |
| Viscosity (cps) | 28 | 25 | 74 | 58 | 43 | 67 |
| Particle Size (nm) | 261 | 184 | 432 | 366 | 313 | 297 |
| pH | 5.3 | 5.3 | 5.6 | 5.3 | 4.6 | 5.1 |
| Mn | 2145 | 2627 | 2445 | — | — | 3435 |
| Mw | 56487 | 38275 | 27464 | — | — | 72939 |
| PD | 26.3 | 14.6 | 11.2 | — | — | 21.2 |

The mini-emulsion examples described above were thickened by the further addition of ammonia and drawdowns were made to obtain dried films of 18 gsm coat weight. The compositions of examples 9 and 10 do not contain any tackifier. The compositions of examples 11 and 12 contain tackifiers that are homogeneously dispersed within the emulsion micelles. Examples 13 and 14 were tested as-is and with the post addition of various pre-dispersed tackifiers at a dry weight content of 25% each. As can be seen from the data shown in Table 3 below, Examples 11 and 12 have the highest tack and peel values due to the homogeneous incorporation of tackifier within the emulsion micelles. As shown in Examples 13 and 14, post adding a pre-dispersed tackifier does improve tack and peel properties but to a lesser degree because they form their own discrete domains in the finished adhesive film and are not homogeneously dispersed.

TABLE 3
Tack, Peel and Shear Properties of Acrylic Modified
Alkyds on Stainless Steel Substrate

| | | | Shear |
|---|---|---|---|
| | Loop Tack | 90° Peel | (1″ × 1″ × 1 Kg) |
| | (N/25 mm) | (N/25 mm) | (Minutes) |
| Example 9 | 3.51 | 5.34 | 18 |
| Example 10 | 4.40 | 0.76 | 2838 |
| Example 11 | 14.23 | 8.41 | 52 |
| Example 12 | 20.06 | 14.77 | 16 |
| Example 13 | 3.87 | 3.2 | 339 |
| Example 13 + | 8.63 | .89 | 537 |
| Tacolyn 3100 | | | |
| Example 13 + | 17.17 | 2.27 | 200 |
| Tacolyn 3570 | | | |
| Example 14 | 4.94 | 4.54 | 219 |
| Example 14 + | 4.54 | 3.47 | 101 |
| Tacolyn 3100 | | | |
| Example 14 + | 9.34 | 5.87 | 133 |
| Tacolyn 3570 | | | |
| Example 14 + | 10.85 | 3.25 | 164 |
| Snowtack FG93C | | | |

An 18 gsm film of the acrylic modified alkyd PSA of Example 9 (internal code # of DH9-17) was bonded to paper facestock and sent to the Compost Manufacturing Alliance for biodegradation testing at the Cedar Grove industrial composting site in Everett, WA. The paper facestock was also tested by itself for determining its relative rate of biodegradation. After 60 days there was still more than 50% of the paper facestock remaining. By comparison, less than 10% material was recovered from the compost pile for the paper facestock/PSA construct. These results show the acrylic modified alkyd PSA biodegraded faster than the paper itself.

What is claimed is:

1. A biodegradable pressure sensitive adhesive comprising:
a water-dispersed composition comprising core-shell polymer nano-sized particles, the core comprising one or more alkyd and the shell comprising a (meth)acrylate polymer, wherein the one or more alkyd is a reaction product of
(i) a non-drying oil or non-drying oil fatty acids and/or esters,
(ii) one or more mono-alcohol, dialcohol, or polyols, and
(iii) one or more mono-carboxylic acid, dicarboxylic acid, or polycarboxylic acid.

2. The pressure sensitive adhesive of claim 1, wherein the non-drying oil or non-drying oil fatty acids and/or esters exhibits an iodine value of less than 125 according to ISO 3961-2018.

3. The pressure sensitive adhesive of claim 1 or 2, wherein the non-drying oil or non-drying oil fatty acids and/or esters exhibit an iodine value of within the range of from about 5 to about 120 according to ISO 3961-2018.

4. The pressure sensitive adhesive of any one of claim 1-3, wherein the non-drying oil or non-drying oil fatty acids and/or esters comprises a total concentration of less than about 20% polyunsaturated fatty acids, and/or fatty acid esters based on the total weight of the one or more alkyd.

5. The pressure sensitive adhesive of any one of claims 1-4, wherein the non-drying oil or non-drying oil fatty acids and/or esters comprises at least one of,
(i) fatty acids and/or fatty acid esters containing zero and/or one site of unsaturation,
(ii) a total concentration of less than about 20% polyunsaturated fatty acids, and/or polyunsaturated fatty acid esters, and
(iii) an iodine value of less than 90 according to ISO 3961-2018.

6. The pressure sensitive adhesive of any one of claims 1-5, wherein the one or more alkyd comprises a polyol and polycarboxylic acid derived from polyethylene terephthalate.

7. The pressure sensitive adhesive of any one of claims 1-6, wherein the one or more alkyd comprises an alcohol, dialcohol, polyalcohol, monocarboxylic acid, dicarboxylic acid or polycarboxylic acid that is bioderived.

8. The pressure sensitive adhesive of any one of claims 1-7, wherein the one or more alkyd comprises a terminal free radically polymerizable functional group.

9. The pressure sensitive adhesive of any one of claims 1-8, wherein the non-drying oil is selected from the group consisting of babassu oil, macadamia oil, almond oil, palm oil, cocoa butter, coconut oil, olive oil, avocado oil, and combinations thereof.

10. The pressure sensitive adhesive of any one of claims 1-9, wherein the weight ratio of the one or more alkyd to the (meth)acrylate polymer is within the range of from about 50:50 to about 95:5 of the core-shell polymer.

11. The pressure sensitive adhesive of any one of claims 1-10, wherein the weight ratio of the alkyd to the (meth)acrylate polymer is within the range of from about 70:30 to about 95:5 of the core-shell polymer.

12. The pressure sensitive adhesive of any one of claims 1-11, wherein the one or more alkyd is covalently bound to the (meth)acrylate polymer.

13. The pressure sensitive adhesive of any one of claims 1-12, further comprising one or more tackifiers.

14. The pressure sensitive adhesive of claim 13, wherein the one or more tackifiers is homogeneously dispersed within the nano-sized core-shell polymer particles.

15. The pressure sensitive adhesive of claim 13 or 14, wherein the tackifier is compatible with the core-shell polymer and does not inhibit free radical polymerization.

16. The pressure sensitive adhesive of any one of claims 13-15, wherein the one or more tackifier is a polyester oligomer having a weight average molecular weight (Mw) within a range of from about 300 g/mole to about 3000 g/mole as determined by gel permeation chromatography (GPC).

17. The pressure sensitive adhesive of any one of claims 1-16 comprising
about 30-80 wt % one or more alkyd;
about 20-50% (meth)acrylate polymer; and
about 0-50 wt % one or more tackifiers;
wherein the weight of the components sums up to 100% based on the total weight of the core-shell polymer.

18. The pressure sensitive adhesive of any one of claims 1-17, wherein the non-drying oil is coconut oil.

19. The pressure sensitive adhesive of any one of claims 1-18, wherein the (meth)acrylate polymer is derived from acrylic acid or acrylates comprising Cl to about C20 alkyl acrylates, methacrylic acid or methacrylates comprising C4 to about C20 alkyl methacrylates, or mixtures thereof.

20. The pressure sensitive adhesive of any one of claims 1-19, wherein the (meth)acrylate polymer is prepared from at least one monomer selected from the group consisting of acrylic acid, methyl acrylate, ethyl acrylate, n-butyl acrylate, iso-butyl acrylate, n-hexyl acrylate, n-heptyl acrylate, n-octyl acrylate, isooctyl acrylate, 2-ethylhexyl acrylate, n-nonyl acrylate, isodecyl acrylate, 2-propyl heptyl acrylate, lauryl acrylate, isostearyl acrylate, β-carboxyethyl acrylate, hydroxyethyl acrylate, hydroxypropyl acrylate, hydroxybutyl acrylate, ethoxyethoxyethyl acrylate, methacrylic acid, n-butyl methacrylate, iso-butyl methacrylate, n-hexyl methacrylate, n-heptyl methacrylate, n-octyl methacrylate, isooctyl methacrylate, 2-ethylhexyl methacrylate, n-nonyl methacrylate, isodecyl methacrylate, 2-propyl heptyl methacrylate, lauryl methacrylate, isostearyl methacrylate, hydroxyethyl methacrylate, hydroxypropyl methacrylate, hydroxybutyl methacrylate and ethoxyethoxyethyl methacrylate.

21. The pressure sensitive adhesive of any one of claims 1-12 further including a surfactant.

22. The pressure sensitive adhesive of any one of claims 1-21 further including a copolymerizable surfactants.

23. The pressure sensitive adhesive of claim 22, wherein the copolymerizable surfactant is selected from the group consisting of allyl or vinyl substituted alkyl phenolethoxylates and their sulfates; block copolymers of polyethylene oxide, propylene oxide or butylene oxide with polymerizable end groups; allyl or vinyl substituted ethoxylated alcohols and their sulfates; maleate half esters of fatty alcohols; monoethanolamide ethoxylates of unsaturated fatty acids capable of undergoing autoxidative polymerization; allyl or vinyl polyalkylene glycol ethers; alkyl polyalkylene glycolether sulfates; functionalized monomer and surfactants; and combinations thereof.

24. The pressure sensitive adhesive of any one of claims 1-23, wherein the (meth)acrylate polymer contains a photoinitiator moiety in the form of a distinct agent that is added to the composition, or a photoinitiator moiety bound to the copolymer backbone, or a photoinitiator moiety formed in-situ by an association of materials or agents in the composition.

25. The pressure sensitive adhesive of claim 24, wherein the photoinitiator is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

26. The pressure sensitive adhesive of any one of claim 24 or 25, wherein the photoinitiator is activatable upon exposure to UV radiation to at least partially polymerize and/or crosslink the composition.

27. The pressure sensitive adhesive of any one of claims 1-26, wherein the composition further comprises additives selected from the group consisting of pigments, fillers, plasticizers, diluents, antioxidants, crosslinkers, chain extenders, and combinations thereof.

28. The pressure sensitive adhesive of any one of claims 1-27, wherein the one or more alkyd exhibits a weight average molecular weight (Mw) within a range of from about 1000 g/mole to about 50,000 g/mole as determined by gel permeation chromatography (GPC).

29. The pressure sensitive adhesive of any one of claims 1-28, wherein the one or more alkyd exhibits a glass transition temperature (Tg) within a range of from about −100° C. to about 50° C. measured by differential scanning calorimetry (DSC).

30. The pressure sensitive adhesive of any one of claims 1-29, wherein the core-shell polymer exhibits a weight average molecular weight (Mw) within a range of from about 5000 g/mole to about 1,000,000 g/mole as determined by gel permeation chromatography (GPC).

31. The pressure sensitive adhesive of any one of claims 1-30, wherein the core-shell polymer exhibits a glass transition temperature (Tg) within a range of from about −100° C. to about 50° C. measured by differential scanning calorimetry (DSC).

32. The pressure sensitive adhesive of any one of claims 1-31, wherein the viscosity of the water-dispersed composition is within a range of from about 5 to about 1500 centipoise (Cp) at 20° C. as measured using a rotational viscometer.

33. The pressure sensitive adhesive of any one of claims 1-32, wherein the viscosity of the water-dispersed composition is within a range of from about 5 to about 500 Cp at 20° C. as measured using a rotational viscometer.

34. The pressure sensitive adhesive of any one of claims 1-33, wherein the particles have a size within a range of from about 10 to about 2000 nm measured by dynamic light scattering.

35. The pressure sensitive adhesive of any one of claims 1-34, wherein the particles have a size within a range of from about 50 to about 600 nm measured by dynamic light scattering.

36. The pressure sensitive adhesive of any one of claims 1-35, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

37. The pressure sensitive adhesive of any one of claims 1-36, wherein the pressure sensitive adhesive exhibits a glass transition temperature (Tg) within a range of from about −100° C. to about 20° C. measured by differential scanning calorimetry (DSC).

38. An article comprising the pressure sensitive adhesive of any one of claim 1-37 or 48-50.

39. The article of claim 38 further comprising:
a substrate defining a face;
wherein the pressure sensitive adhesive is disposed on at least a portion of the face of the substrate.

40. A method for producing the water-dispersed composition of any one of claim 1-37 or 48-50, the method comprising:
dissolving the one or more alkyd, optionally containing one or more crosslinkable moieties, in a monomer mixture to form a polymer-in-monomer solution, wherein the monomer mixture comprises one or more ethylenically unsaturated monomers;
combining with agitation the polymer-in-monomer solution, optionally containing one or more co-stabilizers, with at least one surfactant and a pH modifier dissolved in water to form a pre-emulsion;
agitating the pre-emulsion under high shear to form a mini-emulsion, the mini-emulsion comprising an aqueous continuous phase and an organic disperse phase, and
adding and activating an initiator to polymerize the one or more ethylenically unsaturated monomers to form the core-shell polymer.

41. The method of claim 40, wherein the polymer-in-monomer solution comprises one or more tackifiers.

42. The method of claim 40 or 41, wherein a pre-dispersed tackifier is added to the water-dispersed composition.

43. The method of any one of claim 41 or 42, wherein the tackifier in the polymer-in-monomer solution is the same or different from the pre-dispersed tackifier.

44. The method of any one of claims 40-43, wherein the one or more ethylenically unsaturated monomers is selected from the group consisting of acrylic acid, methyl acrylate, ethyl acrylate, n-butyl acrylate, iso-butyl acrylate, n-hexyl acrylate, n-heptyl acrylate, n-octyl acrylate, isooctyl acrylate, 2-ethylhexyl acrylate, n-nonyl acrylate, isodecyl acrylate, 2-propyl heptyl acrylate, lauryl acrylate, isostearyl acrylate, β-carboxyethyl acrylate, hydroxyethyl acrylate, hydroxypropyl acrylate, hydroxybutyl acrylate, ethoxyethoxyethyl acrylate, methacrylic acid, n-butyl methacrylate, iso-butyl methacrylate, n-hexyl methacrylate, n-heptyl methacrylate, n-octyl methacrylate, isooctyl methacrylate, 2-ethylhexyl methacrylate, n-nonyl methacrylate, isodecyl methacrylate, 2-propyl heptyl methacrylate, lauryl methacrylate, isostearyl methacrylate, hydroxyethyl methacrylate, hydroxypropyl methacrylate, hydroxybutyl methacrylate and ethoxyethoxyethyl methacrylate.

45. The method of any one of claims 40-44, wherein the polymer-in-monomer solution further comprises at least one of a photoinitiator moiety and a monomer containing a photoinitiator moiety.

46. The method of claim 45, wherein the photoinitiator is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

47. The method of any one of claims 40-46, wherein the one or more alkyd core polymer is grafted to the (meth)acrylate polymer shell via free radical polymerization.

48. A biodegradable pressure sensitive adhesive comprising:
a water-dispersed composition comprising core-shell polymer nano-sized particles, the core comprising one or more alkyd and the shell comprising a (meth)acrylate polymer,
wherein the one or more alkyd comprises one or more fatty acids or fatty acid esters derived from a non-drying oil.

49. The pressure sensitive adhesive of any one of claims 2-37 or claim 48, wherein the one or more alkyd comprises c8-c18 fatty acids or fatty acid esters.

50. The pressure sensitive adhesive of any one of claim 2-37, 48 or 49, wherein the non-drying oil or non-drying oil fatty acids and/or esters comprises at least one of,
(i) fatty acids and/or fatty acid esters containing zero and/or one site of unsaturation,
(ii) a total concentration of less than about 50% polyunsaturated fatty acids, and/or polyunsaturated fatty acid esters, and
(iii) an iodine value of less than 125 according to ISO 3961-2018.
